(19) United States
(12) Patent Application Publication
(10) Pub. No.: US 2004/0121678 A1
(43) Pub. Date: Jun. 24, 2004

(54) Liquid impervious and pathogen impervious laminate having antistatic properties

(76) Inventors: A. Frank Baldwin JR., Greensboro, NC (US); Jessica Z. Brown, Oak Ridge, NC (US)

Correspondence Address: MYERS BIGEL SIBLEY & SAJOVEC, PO BOX 37428, RALEIGH, NC, 27627, US

(21) Appl. No.: 10/325,550

(22) Filed: Dec. 19, 2002

(51) Int. Cl. B32B 5/02; B32B 27/04; B32B 27/12; G03B 5/02; G03B 17/04; D04H 1/00; D04H 3/00; D04H 5/00; D04H 13/00; B05D 3/02; D02G 3/00; B32B 27/00; B32B 27/36

(52) U.S. Cl. 442/110; 442/114; 442/115; 442/116; 442/364; 442/394; 442/395; 427/375

(57) ABSTRACT

The present invention provides a liquid impervious and pathogen impervious laminate comprising a breathable layer comprising an antistatic agent and a fibrous layer on the breathable layer. Preferably, the fibrous layer includes a thermally activated adhesive material that is used to bond the fibrous layer and the breathable layer together.

### FIELD OF THE INVENTION

The present invention relates to a laminate which is impervious to various liquids and pathogens, and more specifically a laminate having antistatic properties in addition to the above properties. Such laminates are particularly suited for use as protective apparel, such as surgical, emergency room, and cleanroom gowns.

### BACKGROUND OF THE INVENTION

Hospital gowns, particularly surgical gowns in operating and emergency rooms, are exposed to a variety of liquids which the wearer does not want to contact the wearer's skin. Of significant concern is exposure to body fluids such as blood. Body fluids can permeate through the gown permitting pathogens (e.g., bacteria and viruses) to come in contact with the skin of a wearer. In the hospital environment, of particular concern are the human immunodeficiency virus and hepatitis virus. Thus, liquid repellency is recognized as an essential property in protective apparel used in hospitals.

In addition, such gowns must also possess antistatic properties. The accumulation of static electricity as a result of the use of the fabric is both a safety and a comfort issue. With respect to safety, the buildup of static can cause arcing in medical devices leading to clothing catching on fire or in an extreme scenario explosion of surgical or emergency room gases. Articles of clothing may also become uncomfortable due to clinging to the body. Such clinging can exacerbate the transfer of body fluids to the skin of a wearer.

The gowns, besides being impervious to liquids and pathogens and having antistatic properties, must be comfortable. A key aspect of comfort is breathability. In general, impervious materials do not transmit moisture vapor. As a result, water vapor from perspiration is not transmitted from inside to outside so that no natural evaporative cooling occurs. Ideally, in a continuous film of a hydrophilic material, water vapor is effectively transported through the film on a molecule by molecule basis. The measurement of the rate of this is referred to as moisture vapor transmission rate (“MVTR”).

One solution to the above characteristics is a laminate having a microporous structure and is proposed in U.S. Pat. Nos. 4,433,026 and 5,027,438. U.S. Pat. No. 4,443,511 proposes a layered waterproof, breathable and stretchable article for use in protective articles. The preferred stretchable polymer material is polytetrafluoroethylene. U.S. Pat. No. 4,867,881 proposes an oriented microporous film formed by liquid-liquid phase separation of a crystalline thermoplastic polymer and a compatible liquid. U.S. Pat. Nos. 5,409,761 and 5,560,974 propose a non-woven composite fabric bonded to a thermoplastic microporous film.

U.S. Pat. No. 6,410,465 proposes a fibrous nonwoven comprising a first and second nonwoven web bonded together and bonded to a moisture vapor permeable thermoplastic film using a powder adhesive. The powder adhesive is used for each layer and the webs have different compatibility characteristics with the powder adhesive. There is no disclosure of the use of an antistatic. U.S. Pat. No. 6,187,696 proposes a breathable laminate comprising a nonwoven web and a moisture vapor permeable thermoplastic film of less than 30 μm. EPO 0906192 proposes a moisture vapor permeable thermoplastic film layer bonded directly to a fibrous substrate having at least 50 percent by weight polyolefin fibers. The breathable film contains polyether ester/amide, polyolefin and a compatibilizer. WO 02/18137 proposes a moisture vapor permeable polymer film which is extruded onto a powder bonded nonwoven layer.

These solutions do not suggest the addition of an antistat. If an antistat is added to the fabric layers, it usually will raise the surface energy and wettability of the fabric. This is an undesirable effect. This is usually compensated for by finishing the fabric layers with a combination of water repellent and antistat. This is a costly added step.

However, improvements in protective gowns with respect to being impervious to liquids having antistatic properties and being comfortable continues to be desirable. Thus, it would be desirable to provide an improved laminate that is impervious to liquids and pathogens that has antistatic properties.

### SUMMARY OF THE INVENTION

Accordingly, the present invention provides a liquid impervious and pathogen impervious laminate comprising a breathable layer including an antistatic agent and a fibrous layer on the breathable layer. Preferably, the fibrous layer includes a thermally activated adhesive material that is used to bond the fibrous layer and the breathable layer together.

The breathable layer is preferably monolithic and provides protection from liquids, and from bacterial and viral pathogens such that the laminate exhibits no visible penetration of synthetic blood when subjected to contact with synthetic blood at zero psi for 5 minutes followed by synthetic blood contact at 2 psi (13.6 kPa) for one minute followed by synthetic blood contact at zero psi for 54 minutes according to ASTM F-1670 and exhibit no detectable penetration of virus when tested per ASTM F-1671. Moreover the laminate has an overall moisture vapor transmission rate of at least about 400/grams/sq. meter/24 hours at 72° F. and 50% relative humidity as defined by ASTM E96B. The breathable layer preferably comprises an antistatic agent and a thermoplastic material such that the overall laminate has an electrostatic decay time of less than about 20 seconds at 50% relative humidity. The fibrous layer provides support, and preferably is a nonwoven material.

### DETAILED DESCRIPTION OF THE INVENTION

The invention will now be described with reference to the embodiments set forth herein. These embodiments are intended to illustrate the invention and are not meant to limit the scope of the invention.

In one aspect, the invention relates to a laminate impervious to liquid and impervious to pathogens. The laminate comprises a breathable layer and a fibrous layer on the breathable layer. The breathable layer is preferably monolithic (nonporous) thermoplastic film having incorporated therein an antistatic agent. In one embodiment, the fibrous layer comprises a thermally-activated adhesive material and is bonded to or on the breathable layer using the properties of such adhesive material.

As used herein, the term “laminate” relates to a structure having two or more layers. Such a composite material may also be referred to as a “barrier material.” The laminate or barrier material may be used in apparel, especially protective apparel, such as surgical or emergency room gowns where liquid and pathogen blockage are important. Such protective garments include gowns, coveralls, gloves, arm shields, hoods, boots, aprons, finger cots and the like. Additionally such a laminate may be used in cleanroom or laboratory garments wherein liquid blockage is important along with having antistatic properties.

As used herein, the terms “liquid impervious” and “pathogen impervious” relate to the laminate being a barrier to various liquids, particularly body fluids or liquids potentially bearing bacterial and viral pathogens. Exemplary liquids include blood, water, oil, alcohol, and mixtures thereof. Exemplary bacterial and viral pathogens include hepatitis B virus, hepatitis C virus, human immunodeficiency virus and PhiX174 bacteriophage. Preferably the barrier can prevent passage of any virus of greater than 25 nm from penetrating through the laminate. Inasmuch as bacteria are substantially greater in size than virus, various bacteria will also be prevented from passage.

As used herein, the term “breathable” relates to the overall laminate being able to transfer moisture vapor resulting from perspiration through the article at a rate sufficient to maintain the skin of the wearer in a reasonably dry state during normal conditions. This rate is measured as MVTR.

As used herein, the term “monolithic” relates to a structure that is substantially solid, continuous, sheet-like, non-permeable and contains substantially no holes.

As described above, the breathable layer is preferably a thermoplastic layer or film having incorporated therein an antistatic agent. Suitable thermoplastic resins for preparing these films include polyolefins, polyesters, polyetheresters, polyamides, polyether amides, and urethanes. Examples of suitable thermoplastic polymers include, by way of illustration only, such polyolefins as polyethylene, polypropylene, poly(1-butene), poly(2-butene), poly(1-pentene), poly(2-pentene), poly (3-methyl-1-pentene), poly (4-methyl-1-pentene), 1,2-poly-1,3-butadiene, 1,4-poly-1,3-butadiene, polyisoprene, polychloroprene, polyacrylonitrile, poly(vinyl acetate), poly(vinylidene chloride), polystyrene, and the like; such polyesters as poly(ethylene terephthalate), poly(butylenes)terephthalate, poly(tetramethylene terephthalate), poly(cyclohexylene-1,4-dimethylene terephthalate) or poly(oxymethylene-1,4-cyclohexylenemethyleneoxyterephthaloyl), and the like; such polyetheresters as poly(oxyethylene)-poly(butylene terephthalate), poly(oxytetramethylene)-poly(ethylene terephthalate), and the like; and such polyamides as poly(6-aminocaproic acid) or poly(,-caprolactam), poly(hexamethylene adipamide), poly(hexamethylene sebacamide), poly(11-aminoundecanoic acid), and the like. In one embodiment, the film layer is comprised of a block polyether copolymer such as a block polyetherester copolymer, a polyetheramide copolymer, a polyurethane copolymer, a poly(etherimide) ester copolymer, polyvinyl alcohols, or a combination thereof. Preferred copolyether ester block copolymers are segmented elastomers having soft polyether segments and hard polyester segments, as disclosed in Hagman, U.S. Pat. No. 4,739,012, the disclosure of which is incorporated by reference in its entirety. Suitable copolyether ester block copolymers are sold by DuPont under the name Hytrel®. Suitable copolyether amide polymers are copolyamides available under the name Pebax® from Atochem Inc. of Glen Rock, N.J., USA. Suitable polyurethanes are thermoplastic urethanes available under the name Estane® from the B.F. Goodrich Company of Cleveland, Ohio, USA. Suitable copoly(etherimide) esters are described in Hoeschele et al., U.S. Pat. 4,868,062, the disclosure of which in incorporated by reference in its entirety.

Suitable antistatic agents include quartenary ammonium salts, phosphates, sulfates, sulfonamides, glycerides, inorganic salts (e.g., sodium chloride, calcium, chloride, lithium chloride, sodium sulfate), glycols, ethoxylated fatty acids and alcohols, fatty acid esters and amides, imidazoline, and polyamines. Conductive polymers such as electrically-conductive particles also may be incorporated into the polymer matrix. Exemplary conductive particles include powdered silver, nickel, copper sulfide, carbon black, iron and iron compounds, aluminum, copper, transition metal doped zeolites, metallized fibers, and metallized particles such as metal-coated zeolites or metallized glass beads.

Such a breathable layer will provide a laminate having a MVTR of at least about 400 grams/sq. meter/24 hours, often at least about 600 grams/sq. meter/24 hours, more often at least about 800 grams/sq. meter/24 hours and still more often at least about 900 grams/sq. meter/24 hours at 72° F. and 50% relative humidity as defined by ASTM E96B. Preferably, the MVTR is in the range of 500 to 2000 grams/sq. meter/24 hours.

The film will also provide a laminate having a sufficient strength for the intended end use. For example, if used in a garment the resulting laminate preferably has a grab tensile strength in the cross-machine direction of at least about 10 pounds, or preferably at least about 15 pounds, as defined in ASTM D1117.7. Preferably, the grab tensile strength is in the range of about 8 to 40 pounds.

The resulting laminate preferably exhibits an electrostatic decay time of less tan about 20 seconds, less than about 10 seconds, often less than about 5 seconds, more often less than about 1 second and still more often less than about 0.5 seconds at 50% relative humidity as defined by NFPA-99.

The breathable layer may include additives and modifying agents known in the art. Examples include coloring agents, plasticizers, fillers, binders, pigments, antioxidants, stabilizers, and elastomers.

The fibrous layer provides support for the breathable layer. The fibrous layer of this invention can be of any nonwoven scrim, net, knit, or woven fabric that provides a suitable stable base on which to laminate the breathable layer or film. The fibrous layer can be more than one layer and the breathable layer may be sandwiched between the fibrous layers. The fabric fibers can be composed of, but are not limited to, polyester, cellulosics, nylon, polypropylene, polyethylene, or any combination of a blend of such fibers, the selection of which will be within the skill of one in the art. Suitable methods of formation for nonwoven fabrics include, for example, spunbond, thermalbond, powderbond, resin bond, spunlaced, wet laid, or combinations thereof.

In one embodiment, the fibrous layer is a nonwoven fabric. The nonwoven fabric can be prepared by spunbonding, meltblowing and spunlacing techniques well known in the art. For example, U.S. Pat. 4,405,297 discloses a spunbonding process and U.S. Pat. 3,978,185 discloses a meltblowing process, both of which are incorporated herein by reference in their entirety.

The breathable layer has a thickness of about 0.01 to 1.5 mils and the preferred weight of the breathable layer is from about 0.1 to about 2 oz/sq. yd.. Preferably, the breathable layer has a surface energy of less than about 75 dynes/cm and preferably less than about 50 dynes/cm. Surface energy is important in that the lower the surface energy, the less likely that significant wetting of the resulting fabric will occur thereby reducing the risk of soak through or wicking. The resulting laminate should exhibit no visible penetration of synthetic blood when subjected to contact with synthetic blood at zero psi for 5 minutes followed by synthetic blood contact at 2 psi (13.6 kPa) for one minute followed by synthetic blood contact at zero psi for 54 minutes according to ASTM F-1670. Likewise, the resulting laminate should exhibit no viral penetration when tested per ASTM F-1671 wherein the laminate is contacted with 0.0 slashed.X174 bacteriophage suspension at a titer of 10.sup8 PFU/ml for five minutes with no applied pressure, then 1 minute at 2 psi, then 54 minutes at no applied pressure.

The fabric support preferably has a grab tensile strength of at least about 8 pounds, preferably a trap tear strength of at least about 2.0 pounds, and preferably a Mullen burst strength of at least about 15 psi (net). The fabric support preferably has a basis weight of from about 0.5 to about 3 oz/sq. yd., and the overall laminate has a weight of from about 1 to 4 oz/sq. yd. The fabric preferably has a nice hand and is flexible.

Commercially preferred fabrics for the fiber layer include powder bonded or binder fiber bonded carded nonwovens from HDK Inc., spunlaced polyester/copolyester bicomponent fabrics produced by Green Bay Nonwovens, or spunbonded polypropylene/copolyester fabrics from BBA Nonwovens.

The fabric can be pretreated with property modifiers known in the art for whatever specific end use requirements are needed. Such modifiers include but are not limited to flame retardants, water repellants, antimicrobial agents and softeners and antistatic agents.

An adhesive may be applied to the film or fabric by numerous methods such as rotogravure, spray, or a positive displacement coating. Spray or coating is the most preferred for adhesive add-on control.

The method of thermally-activated adhesive application should preferably allow for discontinuous coating of the adhesive across the breathable layer and/or the fibrous layer to maintain the MVTR of the composite barrier material. Typical adhesive add-on levels for an acceptable bond ranges from about 3 to about 12 grams/sq. meter. The type of adhesive and application method should preferably achieve an acceptable bond between the breathable layer and the fibrous layer with a minimum amount of adhesive. The adhesive, breathable layer, and the fibrous layer fabric support are preferably stable to commercial methods of sterilization, such as gamma irradiation and ethylene oxide and should preferably not exhibit strong or offensive odors after sterilization. The adhesive should preferably not cause a loss of MVTR after lamination.

The breathable layer and the fibrous layer can be joined or bonded together by various thermal bonding techniques including hot calendaring, ultrasonic bonding, point bonding, hot air techniques, radiant heating, infrared heating and the like.

Alternatively, the adhesive or bonding agent can be incorporated into the fibers of the fibrous nonwoven web to aid in the lamination of the film and web. In one embodiment, two different thermally-activated adhesive materials can be used, i.e., a first thermally-activated adhesive and a second thermally-activated adhesive material can be selected. It is important that the temperature used to bond the two layers together be less than the melting point of the constituents of the breathable layer or fibrous layer in order to maintain the integrity of the breathable layer or fibrous layer, thereby reducing the risk of forming pinholes and losing strength during the laminating process. Thus it is important to the present invention that the breathable layer or fibrous layer in its entirety not be allowed to reach its overall melting point and thereby compromise the integrity and barrier properties of the resulting composite. In one embodiment, the melting point of the thermally-activated adhesive material is at least 10° F. less, preferably at least 25° F. less and more preferably at least 50° F. less than the lower of the melting points of the constituents of the fibrous layer and the breathable layer.

By “localizing” heat bonding via the bonding additive and/or a discrete bond pattern, a means is provided to secure attachment with minimal damage to the porous nature of the breathable film layer while at the same time maintaining good flexural characteristics with respect to the overall composite or laminate. Additionally, such a bond pattern may be in a shape or pattern, i.e., a logo or fabric pattern, to provide improved aesthetics to the laminate (garment).

Exemplary adhesive materials include polyamides, ethylene copolymers such as ethylene vinyl acetate (EVA), ethylene ethyl acrylate (EEA), ethylene acrylic acid (EAA), ethylene methyl acrylate (EMA) and ethylene normal-butyl acrylate (ENBA), wood resin and its derivatives, hydrocarbon resins, polyterpene resins, atactic polypropylene and amorphous polypropylene. Also included are predominately amorphous ethylene propylene copolymers commonly known as ethylene-propylene rubber (EPR) and a class of materials referred to as toughened polypropylene (TPP) and olefinic thermoplastic polymers where EPR is mechanically dispersed or molecularly dispersed via in-reactor multistage polymerization in polypropylene or polypropylene/polyethylene blends.

A preferred form of the adhesive is as a powder. Exemplary powder adhesives include polyesters and polyamides such as Grilitex 9, Grilitex D1365E or Grilitex 1531E available from EMS.

In one embodiment, the fibrous layer comprises a thermally-activated adhesive material such as a thermally-activated adhesive fiber. Such a fiber may comprise a core fiber and thermoplastic adhesive sheath surrounding the core fiber. Suitable thermoplastic adhesives include the thermoplastics described above. In one embodiment, the fibrous layer can include a first thermally-activated material comprising a thermally-activated adhesive powder and a second thermally-activated material comprising a thermally-activated adhesive fiber. In another embodiment, the core fiber comprises a condensation polymer and the sheath comprises a thermally-activated adhesive material compatible with the condensation polymer.

The laminate can be made into an article of protective clothing or garment using techniques known to those skilled in the art.

The following example will serve to further exemplify the nature of the invention but should not be construed as a limitation on the scope thereof, which is defined by the appended claims.

### EXAMPLE Example 1

A 0.9 mil copolyetherester breathable monolithic film with a MVTR of 500 g/sq. meter/24 hr (ASTM E-96B) made from DuPont Hytrel® resin is provided. A sulfate antistatic agent is added to the film. A nonwoven polyester fabric available from HDK Inc. has a thickness of 14 mil. A powdered polyester adhesive with a melt point of 120° to 126° C. is added to the fabric such that the fabric is 85 percent fiber and 15 percent adhesive. The breathable monolithic film is laminated to the nonwoven polyester fabric by heating the fabric to a temperature of 325° F. then pressed together with the film using calender rolls. The laminate is cooled to set the bond. The resulting laminate has the following properties:

| | | | Direc- | |
|---|---|---|---|---|
| Property | Method | Units | tion | Value |
| Basis Weight | ASTM D3776 | osy | | 2.62 |
| Thickness | ASTM D1777 | inch | | 0.0012 |
| Grap Tensile | ASTM D5034 | lbf | MD | 24.9 |
| | | | CD | 11.2 |
| Grab Elongation | ASTM D5034 | % | MD | 30.7 |
| | | | CD | 145.1 |
| Trapezoid Tear | ASTM D5733 | lbf | MD | 3.03 |
| | | | CD | 13.2 |
| HOM | INDA 90.3 | g | MD | 60.2 |
| (4″ × 4″)/10 mm gap | | | CD | 18.1 |
| Bond Strength - | AATCC 136 | g | MD | 38.4 |
| Face | | | CD | 66.8 |
| Bond Strength - | AATCC 136 | g | MD | 18.5 |
| Back | | | CD | 27.0 |
| Static Decay | FTM 101C | sec | MD | 1.31 |
| | | | CD | 9.3 |
| Particle Generation | PFG | #/ft³/min | (≧5 μ) | 160 |
| MVTR | ASTM E96B | g/m2/day | | 600 |
| (70° F./50% RH) cup | | | | |

Using ASTM F-1670, there was no visible penetration of synthetic blood at an AQL of 4. Using ASTM F-1671, there was no detectable virus penetration at an AQL of 4.

### Example 2

Two fabrics were prepared by carding polyester fiber into a web and introducing 18 percent by weight of a copolyester adhesive powder. The fabrics were placed on either side of a 30 GSM copolyetherester film that contains an antistat. The film melts at 190° C. One of the composites was bonded overall by heating to 162° C. and applying pressure. Another composite was prepared and then bonded at multiple spaced apart locations using circular dot pattern with approximately 12% bond area. The resulting composites both showed good physical properties with the point bonded material showing a much more flexible handle as measured by a handle-o-meter (H-O-M). In this case the H-O-M data for the flat bonded material was 42 grams-force in the machine direction and 125 grams-force in the cross direction. For the point bonded example, the H-O-M was 11 grams-force in the machine direction, and 27 grams-force in the cross direction.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

That which is claimed is:

1. A liquid impervious and pathogen impervious laminate comprising:
a breathable layer comprising an antistatic agent; and
a fibrous layer on the breathable layer.

2. A laminate according to claim 1, wherein the laminate exhibits an electrostatic decay time of less than about 20 seconds at 50% relative humidity.

3. A laminate according to claim 1, wherein the laminate exhibits an electrostatic decay time of less than about 10 seconds at 50% relative humidity.

4. A laminate according to claim 1, wherein the laminate exhibits an electrostatic decay time of less than about 5 seconds at 50% relative humidity.

5. A laminate according to claim 1, wherein the laminate exhibits an electrostatic decay time of less than about 1 second at 50% relative humidity.

6. A laminate according to claim 1, wherein the laminate exhibits an electrostatic decay time of less than about 0.5 seconds at 50% relative humidity.

7. A laminate according to claim 1, wherein the laminate provides for a moisture vapor transmission rate of at least about 400 grams/sq. meter/24 hours at 72° F. and 50% relative humidity according to ASTM E96B.

8. A laminate according to claim 1, wherein the laminate has a grab tensile strength in the machine direction of at least about 25 pounds.

9. A laminate according to claim 1, wherein the laminate has a grab tensile strength in the cross-machine direction of at least about 10 pounds.

10. A laminate according to claim 1, wherein the laminate has a weight of from about 1 to 4 ounces per square yard.

11. A laminate according to claim 1, wherein the laminate exhibits no visible penetration of synthetic blood when subjected to contact with synthetic blood at zero psi for 5 minutes followed by synthetic blood contact at 2 psi (13.6 kPa) for one minute followed by synthetic blood contact at zero psi for 54 minutes according to ASTM F1670.

12. A laminate according to claim 1, wherein the laminate exhibits no detectable virus penetration when tested per ASTM F-1671.

13. A laminate according to claim 1, wherein the breathable layer is a monolithic layer.

14. A laminate according to claim 13, wherein the breathable layer comprises a copolyetherester.

15. A laminate according to claim 13, wherein the breathable layer comprises a copolyetheramide.

16. A laminate according to claim 13, wherein the breathable layer comprises a urethane.

17. A laminate according to claim 1, wherein the breathable layer is a microporous layer.

18. A laminate according to claim 1, wherein the breathable layer has a thickness of between about 0.01 and 1.5 mils.

19. A laminate according to claim 1, wherein the breathable layer comprises a thermoplastic material.

20. A laminate according to claim 19, wherein the thermoplastic material is selected from the group consisting of copolyetherester, copolyetheramide, and urethane.

21. A laminate according to claim 1, wherein the antistatic agent is selected from the group consisting of conductive polymers, quartenary ammonium salts, phosphates, sulfates, sulfonamides, glycerides, inorganic salts, glycols, ethoxylated fatty acids and alcohols, fatty acid esters and amides, imidazoline, and polyamines.

22. The laminate according to claim 1 wherein there are more than one fibrous layers.

23. The laminate according to claim 1, wherein the fibrous layer includes an antistatic agent.

24. A laminate according to claim 1, wherein the fibrous layer has a surface energy of less than 75 dynes/cm.

25. A laminate according to claim 1, wherein the fibrous layer has a surface energy of less than 50 dynes/cm.

26. A laminate according to claim 1, wherein the fibrous layer is a nonwoven fabric.

27. A laminate according to claim 1, wherein the fibrous layer is a woven fabric.

28. A laminate according to claim 1, wherein the fibrous layer is a knit fabric.

29. A laminate according to claim 1, wherein the fibrous layer comprises a polyester.

30. A laminate according to claim 1, wherein the breathable layer is directly on the fibrous layer.

31. A laminate according to claim 1, wherein the fibrous layer is bonded to the breathable layer.

32. A laminate according to claim 1, wherein the fibrous layer is adhesive bonded to the breathable layer.

33. A laminate according to claim 1, wherein laminate prevents passage of viruses greater than 25 nm.

34. A garment for use in a medical environment, said garment comprising a laminate according to claim 1.

35. A breathable impervious gown comprising a laminate according to claim 1.

36. A cloth laminate comprising:
a breathable thermoplastic layer comprising an antistatic agent such that the laminate exhibits an electrostatic decay time of less than about 20 seconds; and
a nonwoven fibrous layer bonded to the breathable thermoplastic layer, wherein the nonwoven fibrous layer has a surface energy of less than 75 dynes/cm.

37. A cloth laminate according to claim 36, wherein the antistatic agent is selected from the group consisting of conductive polymers, quartenary ammonium salts, phosphates, sulfates, sulfonamides, glycerides, inorganic salts, glycols, ethoxylated fatty acids and alcohols, fatty acid esters and amides, imidazoline, and polyamines.

38. A cloth laminate comprising:
a breathable monolithic thermoplastic layer comprising an antistatic agent such that the laminate exhibits an electrostatic decay time of less than about 20 seconds; and
a nonwoven thermoplastic fibrous layer bonded to the breathable monolithic thermoplastic layer, wherein the nonwoven thermoplastic fibrous layer has a surface energy of less than 50 dynes/cm.

39. A cloth laminate comprising:
a breathable thermoplastic layer comprising an antistatic agent such that the laminate exhibits an electrostatic decay time of less than about 10 seconds at 50% relative humidity; and
a nonwoven fibrous layer bonded to the breathable thermoplastic layer, wherein the nonwoven fibrous layer has a surface energy of less than 75 dynes/cm;
wherein the laminate exhibits no visible penetration of synthetic blood when subjected to contact with synthetic blood at zero psi for 5 minutes followed by synthetic blood contact at 2 psi (13.6 kPa) for one minute followed by synthetic blood contact at zero psi for 54 minutes according to ASTM F1670.

40. A cloth laminate according to claim 39, wherein cloth laminate prevents passage of viruses greater than 25 nm.

41. A cloth laminate comprising:
a breathable thermoplastic layer comprising an antistatic agent such that the laminate exhibits an electrostatic decay time of less than about 20 seconds at 50% relative humidity; and
a nonwoven fibrous layer bonded to the breathable thermoplastic layer, wherein the nonwoven fibrous layer has a surface energy of less than 75 dynes/cm;
wherein the laminate exhibits no detectable virus penetration when tested per ASTM F-1671

42. A cloth laminate according to claim 41, wherein cloth laminate prevents passage of viruses greater than 25nm.

43. A layered structure comprising:
a breathable layer comprising an antistatic agent; and
one or more fibrous layers contacting the breathable layer, wherein at least one of the one or more fibrous layers comprise a thermally-activated adhesive material.

44. A structure according to claim 43, wherein the fibrous layer comprises:
at least about 65 percent fiber material(s); and
at least about 10 percent thermally-activated adhesive material(s).

45. A structure according to claim 43, wherein the fibrous layer comprises:
between about 65 and 90 percent fiber material(s); and
between about 10 and 35 percent thermally-activated adhesive material(s).

46. A structure according to claim 43, wherein the thermally-activated adhesive material is a thermally-activated adhesive powder.

47. A structure according to claim 46, wherein the thermally-activated adhesive powder comprises a copolyester adhesive.

48. A structure according to claim 46, wherein the thermally-activated adhesive powder is distributed within the one ore more fibrous layers in a selected shape or pattern.

49. A structure according to claim 46, wherein the thermally activated adhesive is heated with a heated patterned roll to impart bonding and patterning in a selected shape or pattern.

50. A structure according to claim 48, wherein the shape or pattern is a logo.

51. A structure according to claim 48, wherein the shape or pattern is a fabric pattern.

52. A structure according to claim 49, wherein the shape or pattern is a logo.

53. A structure according to claim 49, wherein the shape or pattern is a fabric pattern.

54. A structure according to claim 43, wherein the thermally-activated adhesive material is a thermally-activated adhesive fiber.

55. A structure according to claim 54, wherein the thermally-activated adhesive fiber comprises:
a core fiber; and
an adhesive sheath surrounding the core fiber.

56. A structure according to claim 55, wherein the core fiber comprises polyester and the sheath comprises a copolyester adhesive.

57. A structure according to claim 43, wherein the fibrous layer further comprises a thermoplastic material and the breathable layer further comprises a thermoplastic material.

58. A structure according to claim 57, wherein the melting point of the thermally-activated adhesive material is less than the melting point of the thermoplastic material in the fibrous layer and less than the melting point of the thermoplastic material in the breathable layer.

59. A structure according to claim 56, wherein the melting point of the thermally-activated adhesive material is at least 50° F. less than the lower of the melting points of the thermoplastic material in the fibrous layer and the thermoplastic material in the breathable layer.

60. A structure according to claim 43, wherein the fibrous layer comprises a first thermally-activated adhesive material and a second thermally-activated adhesive material.

61. A structure according to claim 60, wherein the first thermally-activated adhesive material is a thermally-activated adhesive powder and the second thermally-activated adhesive material is a thermally-activated adhesive fiber.

62. A structure according to claim 61, wherein the melting point of the first thermally-activated adhesive material is different from the melting point of the second thermally-activated adhesive material.

63. A structure according to claim 60, wherein the fibrous layer further comprises a thermoplastic material and the breathable layer further comprises a thermoplastic material.

64. A structure according to claim 62, wherein the melting points of the first thermally-activated adhesive material and the second thermally-activated adhesive material are each less than the melting point of the thermoplastic material in the fibrous layer and less than the melting point of the thermoplastic material in the breathable layer.

65. A nonwoven fabric composite comprising:
a breathable film comprising an antistatic agent and a thermoplastic material; and
a nonwoven fabric layer bonded to the breathable film, wherein the nonwoven fabric layer has a surface energy of less than 70 dynes/cm;
wherein said composite exhibits an electrostatic decay time of less than about 20 seconds at 50% relative humidity;
wherein said composite provides for a moisture vapor transmission rate of at least about 400 grams/sq. meter/24 hours at 72° F. and 50% relative humidity according to ASTM E96B;
wherein said composite has a grab tensile strength in the machine direction of at least about 15 pounds;
wherein said composite has a grab tensile strength in the cross-machine direction of at least about 10 pounds;
wherein said composite has a thickness between about 10 and 50 mils;
wherein said composite has a weight of from about 1 to 4 ounces per square yard; and
wherein said composite exhibits no visible penetration of synthetic blood when subjected to contact with synthetic blood at zero psi for 5 minutes, followed by synthetic blood contact at 2 psi for one minute, followed by synthetic blood contact at zero psi for 54 minutes according to ASTM F1670.

66. A composite according to claim 65, wherein laminate prevents passage of viruses greater than 25 nm.

67. A nonwoven fabric composite comprising:
a breathable film comprising an antistatic agent and a thermoplastic material; and
a nonwoven fabric layer bonded to the breathable film, wherein the nonwoven fabric layer has a surface energy of less than 70 dynes/cm;
wherein said composite exhibits an electrostatic decay time of less than about 20 seconds at 50% relative humidity;
wherein said composite provides for a moisture vapor transmission rate of at least about 400 grams/sq. meter/24 hours at 72° F. and 50% relative humidity according to ASTM E96B;
wherein said composite has a grab tensile strength in the machine direction of at least about 15 pounds;
wherein said composite has a grab tensile strength in the cross-machine direction of at least about 10 pounds;
wherein said composite has a thickness between about 10 and 50 mils;
wherein said composite has a weight of from about 1 to 4 ounces per square yard; and
wherein the laminate exhibits no detectable virus penetration when tested per ASTM F-1671.

68. A composite according to claims 67, wherein laminate prevents passage of viruses greater than 25 nm.

69. A composite according to claim 67, wherein the breathable film is a monolithic film.

70. A composite according to claim 67, wherein the breathable film comprises a copolyetherester.

71. A composite according to claim 67, wherein the breathable layer comprises a copolyetheramide.

72. A composite according to claim 67, wherein the breathable layer comprises a urethane.

73. A composite according to claim 67, wherein the nonwoven fabric layer comprises a polyester.

74. A garment for use in a medical environment comprising the composite of claim 67.

75. A breathable impervious gown comprising the composite of claim 67.

76. A garment for use in a medical environment, said garment comprising
a nonwoven fabric composite that comprises:
a breathable monolithic film comprising a copolyetherester and an antistatic agent; and
a nonwoven fabric layer comprising a polyester, said nonwoven fabric layer bonded to the breathable monolithic film, wherein the nonwoven fabric layer has a surface energy of less than 70 dynes/cm;
wherein said composite exhibits an electrostatic decay time of less than about 1 second at 50% relative humidity;
wherein said composite provides for a moisture vapor transmission rate of at least about 400 grams/sq. meter/24 hours at 72° F. and 50% relative humidity according to ASTM E96B;
wherein said composite has a grab tensile strength in the cross-machine direction of at least about 10 pounds;
wherein said composite has a thickness between about 10 and 50 mils;
wherein said composite has a weight of from about 1 to 4 ounces per square yard; and
wherein said composite exhibits no visible penetration of synthetic blood when subjected to contact with synthetic blood at zero psi for 5 minutes, followed by synthetic blood contact at 2 psi for one minute, followed by synthetic blood contact at zero psi for 54 minutes according to ASTM F1670.

77. A garment according to claim 76, wherein the breathable layer comprises a thermoplastic material.

78. A garment according to claim 76, wherein the breathable monolithic layer is adhesive bonded to the nonwoven fabric layer such that the adhesive forms a predetermined shape or pattern visible on a surface of the garment.

79. A garment according to claim 78, wherein the predetermined shape or pattern is a logo.

80. A garment according to claim 78, wherein the breathable monolithic layer is adhesively bonded to the nonwoven fabric layer and heated with a heated patterned roller to impart bonding and patterning in a selected shape or pattern.

81. A garment according to claim 76, wherein the garment is a breathable imprevious gown.

82. A garment for use in a medical environment, said garment comprising
a nonwoven fabric composite that comprises:
a breathable monolithic film comprising a copolyetherester and an antistatic agent; and
a nonwoven fabric layer comprising a polyester, said nonwoven fabric layer bonded to the breathable monolithic film, wherein the nonwoven fabric layer has a surface energy of less than 70 dynes/cm;
wherein said composite exhibits an electrostatic decay time of less than about 1 second at 50% relative humidity;
wherein said composite provides for a moisture vapor transmission rate of at least about 400 grams/sq. meter/24 hours at 72° F. and 50% relative humidity according to ASTM E96B;
wherein said composite has a grab tensile strength in the cross-machine direction of at least about 10 pounds;
wherein said composite has a thickness between about 10 and 50 mils;
wherein said composite has a weight of from about 1 to 4 ounces per square yard; and
wherein the laminate exhibits no detectable virus penetration when tested per ASTM F-1671.

83. A garment according to claim 82, wherein the breathable layer comprises a thermoplastic material.

84. A garment according to claim 82, wherein the breathable monolithic layer is adhesive bonded to the nonwoven fabric layer such that the adhesive forms a predetermined shape or pattern visible on a surface of the garment.

85. A garment according to claim 84, wherein the predetermined shape or pattern is a logo.

86. A garment according to claim 84, wherein the breathable monolithic layer is adhesively bonded to the nonwoven fabric layer and heated with a heated patterned roller to impart bonding and patterning in a selected shape or pattern.

87. A garment according to claim 82, wherein the garment is a breathable imprevious gown.

88. A method of manufacturing a cloth laminate comprising:
heating a layered structure comprising a breathable layer, which comprises an antistatic agent, on a fibrous layer that comprises a thermally-activated adhesive material, such that the thermally-activated adhesive material in the fibrous layer melts and bonds the breathable layer to the fibrous layer to provide the cloth laminate.

89. A method according to claim 88, wherein the breathable layer comprises a thermoplastic material having a melting point higher than the melting point of the thermally-activated adhesive material, and the heating of the layered structure is performed at a temperature less than the melting point of the thermoplastic material in the breathable layer.

90. A method according to claim 89, wherein the thermoplastic material in the breathable layer comprises a copolyetherester, copolymeramide or urethane.

91. A method according to claim 88, wherein the fibrous layer comprises a thermoplastic material having a melting point higher than the melting point of the thermally-activated adhesive material, and the heating of the layered structure is performed at a temperature less than the melting point of the thermoplastic material in the fibrous layer.

92. A method according to claim 88, wherein the thermoplastic material in the fibrous layer comprises a polyester.

93. A method according to claim 88, wherein the breathable layer comprises a thermoplastic material having a melting point higher than the melting point of the thermally-activated adhesive material, and the fibrous layer comprises a thermoplastic material having a melting point higher than the melting point of the thermally-activated adhesive material, and wherein the heating of the layered structure is performed at a temperature less than the melting point of the thermoplastic material in the breathable layer and less than the melting point of the thermoplastic material in the fibrous layer.

94. A method according to claim 88, wherein the thermally-activated adhesive material comprises a copolyester adhesive.

95. A method according to claim 88, wherein the thermally-activated adhesive material is a thermally-activated adhesive powder.

96. A method according to claim 95, wherein the thermally-activated adhesive powder is distributed within the fibrous layer such that the heating of the layered structure causes the thermally-activated adhesive powder to melt, forming a predetermined shape or pattern visible on the cloth laminate.

97. A method according to claim 96, wherein the predetermined shape or pattern comprises a logo.

98. A method according to claim 88, wherein the thermally-activated adhesive material is a thermally-activated adhesive fiber.

99. A method according to claim 98, wherein the thermally-activated adhesive fiber comprises:
a core fiber; and
an adhesive sheath surrounding the core fiber.

100. A method according to claim 99, wherein the core fiber comprises a condensation polymer and the sheath comprises a thermally-activated adhesive material compatible with a condensation polymer.

101. A method according to claim 100, wherein the condensation polymer is a polyester.

102. A method according to claim 100, wherein the thermally-activated adhesive material compatible with a condensation polymer is a copolyester adhesive material.

103. A method according to claim 99, wherein the core fiber comprises an olefinic polymer.

104. A method according to claim 103, wherein the olefinic polymer is polypropylene.

105. A method according to claim 104, wherein the sheath comprises a copolyester adhesive material.

106. A method according to claim 98, wherein the fibrous material comprises a first thermally-activated adhesive material and a second thermally-activated adhesive material.

107. A method according to claim 106, wherein the first thermally-activated adhesive material is a thermally-activated adhesive powder and the second thermally-activated adhesive material is a thermally-activated adhesive fiber.

108. A method according to claim 106, wherein the first thermally-activated adhesive material has a melting point lower than the melting point of the second thermally-activated adhesive material.

109. A method according to claim 108, wherein the heating of the layered structure comprises heating the layered structure to a temperature above the melting point of the first thermally-activated adhesive material, but below the melting point of the second thermally-activated adhesive material.

110. A method according to claim 109, further comprising
heating the layered structure to a temperature above the melting point of the second thermally-activated adhesive material.

111. A method of manufacturing a nonwoven fabric composite comprising:
melting a thermally-activated adhesive material in a nonwoven fabric layer such that the melted adhesive material bonds the nonwoven fabric layer to a breathable film on the nonwoven fabric layer, wherein the breathable film comprises an antistatic agent.

112. A method of manufacturing a nonwoven fabric composite comprising: activating a thermally-activated adhesive material in a nonwoven fabric layer such that the activated adhesive material bonds the nonwoven fabric layer to a breathable film on the nonwoven fabric layer, wherein the breathable film comprises an antistatic agent.
